(19) United States
(12) Patent Application Publication
(10) Pub. No.: US 2016/0052619 A1
(43) Pub. Date: Feb. 25, 2016

(54) SIMPLIFIED INVERTED V-TAIL STABILIZER FOR AIRCRAFT

(71) Applicant: Christopher Gagliano, Melbourne, FL (US)

(72) Inventor: Christopher Gagliano, Melbourne, FL (US)

(21) Appl. No.: 14/548,635

(22) Filed: Nov. 20, 2014

Related U.S. Application Data
(60) Provisional application No. 61/908,064, filed on Nov. 23, 2013.

(51) Int. Cl. B64C 5/02; B64D 27/20; B64C 5/08; B64C 39/10; B64C 5/10

(52) U.S. Cl. CPC B64C 5/02; B64C 39/10; B64C 5/10; B64C 5/08; B64D 27/20

(57) ABSTRACT

The simplified inverted V-tail aircraft comprise of fixed inverted V-tail stabilizers, wing mounted elevons, with no moving control surfaces attached to the fixed inverted V-tail stabilizers. Elevons act as elevators as well as aileron elements and rudders and the design is simplified, making construction far less costly. No control cables or other control devices are required to be routed to the inverted V-tail. Moreover, the number of control surfaces is reduced and limited to the wing portion of the aircraft. The inverted V-tail may thus be made in one piece, for example, using composites, thus simplifying construction considerably.

### CROSS-REFERENCE TO RELATED APPLICATIONS

The present application claims priority from Provisional U.S. Patent Application No. 61/908,064 filed on Dec. 19, 2013, and incorporated herein by reference.

### FIELD OF THE INVENTION

The present invention relates to stabilizing an aircraft in flight, specifically an improved structure over conventional and non-conventional aircraft designs to include flying wing type aircraft.

### BACKGROUND OF THE INVENTION

Applicant's previous U.S. Pat. No. 5,979,824, issued Nov. 9, 1999, is incorporated herein by reference. In that patent, it was noted that aircraft have been flown with various tail arrangements, or no tail arrangement, also known as a flying wing since the original Wright Brothers aircraft of 1903.

FIG. 1-A and FIG. 1-B illustrate a prior art conventional inverted “V” tail. One type of aircraft (FIG. 1-A) known as the conventional inverted “V” tail has been flown and tested showing evidence of improved performance but the overall concept was ill conceived by means of a complicated system to blow engine exhaust down the twin booms and over the tail surfaces. Additional design problems include overly long and heavy main landing gear.

Conventional inverted “V” tail designs present a basic configuration design problem—providing overly complicated, and expensive control system located at the tail thus the reason the conventional inverted “V” tail arrangement is not popular.

Conventional inverted “V” tails require heavier tail structures necessary to support the combined load of the two angled control surfaces known as ruddervators. Conventional inverted “V” tail ruddervators require more maintenance, add weight and are costly to manufacture and install.

FIG. 2-A shows a perspective view of a basic version of applicant's Prior Art inverted “V” tail aircraft 28. The boom 14 is made from aircraft grade carbon fiber and epoxy available from Aircraft Spruce and Specialty, Fullerton, Calif. However, the boom 14 may be fabricated out of any aircraft grade material as long as the required strength and weight considerations are properly addressed.

Two (2) each booms 14 extend aft approximately three (3) times the length of the mean aerodynamic cord of the wing at which point the fin stabilizers 16 made from aircraft grade fiberglass, foam and epoxy available from Aircraft Spruce and Specialty, Fullerton, Calif. However, the fin stabilizers 16 could be made from any aircraft grade material as long as the required strength and weight considerations are properly addressed. The booms 14 and fins stabilizers 16 may be chemically bonded (epoxy) or mechanically attached with either aircraft grade rivets, bolts or screws. Left and right fin stabilizers 16 are connected at the top of each assembly either by chemically bonding (epoxy) or mechanically attached with either aircraft grade, rivets, bolts or screws.

As shown in FIG. 3-A and FIG. 3-B, the existing use of boom supported inverted “V” tail stabilizers 16 is very different from applicant's present invention. In the existing design of FIG. 3-B air pressure generated by forward thrust strikes the Ruddervators 20, altering the direction of flight

FIG. 4 shows a perspective view of one possible method of attaching the stabilizer booms 14 to the main spar 06 and rear spar 08 with a forward attach fitting 10 and an aft attach fitting 12 with bolts 26.

Additional embodiments of applicant's Prior Art inverted V-tail are illustrated in FIG. 2-B. In this case, radar (radio detecting and ranging) waves 24 strike the fin stabilizers 16 at an oblique angle reflecting away from the point of emission thus making the aircraft generate a smaller radar signature.

Accordingly, the reader will see that the inverted “V” structure is suitable for many aircraft types and different engine configurations. In addition, the structure is most suitable for composite construction but equally adaptable to conventional aluminum construction.

FIG. 5 shows a perspective view of typical prior art of a flying wing aircraft as illustrated for example, in U.S. Pat. Nos. D143,852, issued Feb. 12, 1946 and D314,355 issued Feb. 5, 1991, both of which are incorporated herein by reference. Referring to FIG. 5, aircraft 30 is provided with elevons 34 for pitch and roll control and drag rudders 36 for yaw control.

Conventional flying wing aircraft where there is no tail structure, such as illustrated in FIG. 5, present a basic configuration design problem—providing no inherent stability in roll, yaw and pitch control of the aircraft and thus this arrangement is not popular.

Conventional flying wing aircraft, also known as tailless aircraft require very careful design considerations to assure even a pilot of advanced skills can fly the aircraft in a safe manner. Many of such aircraft require a “fly by wire” computer system, as the aircraft may be dynamically unstable in flight.

Conventional flying wing aircraft require both wingtip mounted split drag rudders 36 and elevons 34 for a total of six independent surfaces, this large number of control surfaces require additional maintenance that add both weight and cost to the design.

### BRIEF SUMMARY OF THE INVENTION

The simplified fin stabilizers comprises an aircraft having fixed inverted V-tail stabilizers, and wing mounted elevons. In this embodiment, no movable control surfaces are provided on the simplified inverted V-tail stabilizers. In this embodiment, design is simplified, making construction far less costly. No control cables or other control devices are required to be routed to the inverted V-tail. Moreover, the number of control surfaces is reduced and limited to the wing portion of the aircraft. The simplified inverted V-tail may thus be made in one piece, for example, using composites, thus simplifying construction considerably.

In operation, the simplified inverted V-tail stabilizers operates unlike the conventional inverted V-tail of the Prior Art as the wing mounted elevons provide both roll and pitch control thus doing away with the elevator, rudder, horizontal stabilizer, vertical stabilizer, stabilator, strakes, and ruddervator that are normally found on the tail of an aircraft.

The Simplified Inverted V-Tail Stabilizers results in a tail assembly that has fewer parts, is lighter, safer and less costly to manufacture. In addition, using wing mounted elevons for basic flight control vastly increases the effectiveness of the Simplified Inverted V-Tail Stabilizers thus yaw stability of the aircraft is improved thus reducing or eliminating the chance of the pilot losing control of the aircraft. Basic construction can utilize aluminum or composite fiberglass/carbon cloth and epoxy resin.

Various full scale powered aircraft, sailplanes, powered motor gliders, unmanned aircraft, or amateur built full scale or model aircraft can utilize this new invention as it will be lighter, less expensive to manufacture, provide better handling and will create less drag thus the simplified aircraft of the present invention will be more economical to operate than conventional aircraft designs.

If the aircraft suffers a mechanical malfunction requiring the pilot or passenger to bail out, by virtue of the simplified fin stabilizers being separated along the centerline of the aircraft, the probability of hitting the tail structure is greatly reduced thus enhancing the chances of a survivable escape. (See FIG. 6-A).

Accordingly, several objects and advantages of our invention are:
a. To provide shorter, lighter landing gear that creates less drag and a lighter structure;
b. To provide stronger landing gear, shorter landing gear create less bending stress during take-off and landing; and

Further objects and advantages are:
a. To provide a structure that can channel engine thrust between the stabilizers which creates less drag, vibration and stress on the airframe;
b. To provide a structure that because the engine is mounted close to the aircrafts center of gravity no major changes in fuselage length or stabilizer location need take place if a heavy more powerful engine is installed;
c. To provide a structure that has less profile drag due to the smaller diameter aft fuselage making the aircraft more fuel efficient;
d. To provide a structure that has fewer detail parts, reducing the cost of manufacturing;
e. To provide a structure that acts as a propeller guard if the aircraft is built with a pusher type engine installation; and
f. To provide a structure that is structurally stronger, allowing the aspect ratio of the stabilizer to be greater than most conventional built aircraft which is a proven method of increasing performance and reducing fuel consumption.

Further objects and advantages of my invention will become apparent from a consideration of drawings and ensuing description.

### BRIEF DESCRIPTION OF THE SEVERAL VIEWS OF THE DRAWINGS

FIG. 1-A shows a rear view of Prior Art conventional inverted “V” tail aircraft.

FIG. 1-B is a prospective view of a Prior Art conventional inverted “V” tail aircraft.

FIG. 2-A is a prospective view of an aircraft utilizing applicant's Prior Art inverted “V” boom supported stabilizers.

FIG. 2-B shows a rear view of applicant's Prior Art inverted “V” boom supported stabilizers and how radar waves are deflected away from the aircraft.

FIG. 3-A is a prospective view of an aircraft utilizing applicant's Prior Art inverted “V” boom supported stabilizers.

FIG. 3-B shows a rear view of applicant's Prior Art inverted “V” tail Ruddervators deflected thus allowing the aircraft to change the direction of flight.

FIG. 4 shows one of many ways the stabilizer booms could be attached to the main wing structure.

FIG. 5 is a perspective view of a flying wing aircraft that uses elevons for pitch and roll control.

FIG. 6-A is a perspective view of the simplified inverted V-tail stabilizer of the present invention.

FIG. 6-B shows a rear view of simplified aircraft with elevons deflected thus allowing the aircraft to change the direction of flight.

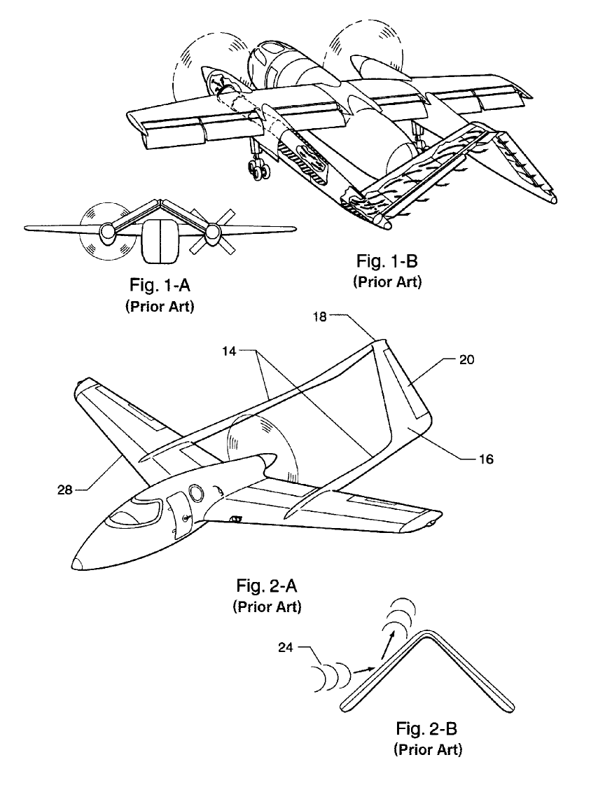

### REFERENCE NUMERALS IN DRAWINGS

The following reference numerals are used in the drawings accompanying the present application, including drawings illustrating the Prior Art embodiments. For the purposes of brevity, elements in common with the Prior Art Figures are not illustrated in the Drawings illustrating the present invention.

| 06 Main Spar | 08 Rear Spar | 10 Attach Fitting |
|---|---|---|
| 12 Aft Boom Attach | 14 Boom | 16 Fin Stabilizer |
| 18 L/R Fin Attachment | 20 Ruddervators | 24 Radar Waves |
| 26 Attach Bolts | 28 Conventional Inverted V Tail Aircraft | |
| 30 Flying Wing Aircraft | 34 Elevons | 36 Drag Rudders |
| 800 Simplified Aircraft | 810 Fuselage | 801 Engine |
| 802 Wing | 811Simplified Inverted V-Tail Stabilizers | |
| 816 Elevons | | |

### DETAILED DESCRIPTION OF THE INVENTION

The innovative design as described below yields a number of unique and sustaining advantages that are currently not found in the most advanced, state of the art aircraft.

This invention referred to in this Provisional Patent Application is called a “Simplified Inverted V-Tail Stabilizer for Aircraft” and was discovered while working on a new aviation product as defined by Gagliano, U.S. Pat. No. 5,979,824, entitled “Stabilizer Fins-Inverted for Aircraft,” issued Nov. 9, 1999 and incorporated by reference. Extensive research regarding the best, most reliable way to control an aircraft lead the inventor to combine superior features of both Inverted V-Tail stabilizers and new elevon controls used on the Northrop YB-35 and the Northrop Grumman B2 aircraft.

Simplified Inverted V-Tail Stabilizers can be used in various types of aircraft, such as small general aviation aircraft, unmanned air vehicles (UAV) and military or commercial aircraft. The superior simplicity of a Simplified Inverted V-Tail Stabilizer results in a structure that is 1) lighter than current aircraft, 2) less costly to manufacture, 3) vastly increases the yaw stability/control of the aircraft.

FIG. 6-A is a perspective view of the simplified inverted V-tail stabilizer of the present invention. Referring to FIG. 6-A, simplified inverted V-tail stabilizers comprise of a simplified aircraft 800 having a fuselage 810, fixed simplified inverted V-tail stabilizers 811, and elevons 816. In this embodiment, rudders or other movable control surfaces are not part of the simplified inverted V-tail stabilizers 811. Elevons 816 act as both elevators as well as aileron elements and may be used as split rudders as well. Jet engine or other thrust generating means maybe provided such that thrust passes between and beneath the simplified inverted V-tail stabilizer 811.

As shown in FIG. 6-A, the manner of using the boom supported inverted “V” tail is similar to that of the inverted “V” tail in present use. Namely, air pressure generated by forward thrust flows past the simplified fin stabilizers 811, aerodynamically balancing the aircraft around the center of gravity of said aircraft.

As shown in FIG. 6-A when a blast of air (generated by either engine thrust or forward motion or a combination of both) passes from the front to the rear of the simplified fin stabilizer 811, a pressure force is equally created all around the simplified fin stabilizer 811. If the nose of the aircraft rotates either; down, up, left or right around the aircraft's center of gravity, the air pressure will become unbalanced, striking the simplified fin stabilizers 811 at an oblique angle thus forcing the simplified aircraft 800 to return to a neutral or balanced equilibrium in relation to original direction of flight.

To intentionally make the aircraft change course, (i.e., nose up or down, nose right or nose left), the pilot must actuate cockpit controls. Namely aileron and elevator controls which are connected by a mechanical mixer to the elevons 816 (combination aileron and elevator) which in turn will deflect and unbalance the air pressure around the elevon 816. This effect will cause the nose to rotate around the aircraft center of gravity in the direction the pilot wishes to go. Reversing the direction the controls were initially moved to will stop the rotation and return the aircraft to a neutral or balanced equilibrium.

In this embodiment, design is simplified, making construction far less costly. No control cables or other control devices are required to be routed to the inverted V-tail. Moreover, the number of control surfaces is reduced and limited to the wing portion of the aircraft. The inverted V-tail may thus be made in one piece, for example, using composites, thus simplifying construction considerably.

In operation, the simplified inverted V-tail stabilizers operates unlike the conventional inverted V-tail of the Prior Art, however, the wing mounted elevons provide both roll and pitch control thus doing away with the elevator, rudder, horizontal stabilizer, vertical stabilizer, stabilator, strakes or ruddervators that are normally found on the tail of an aircraft.

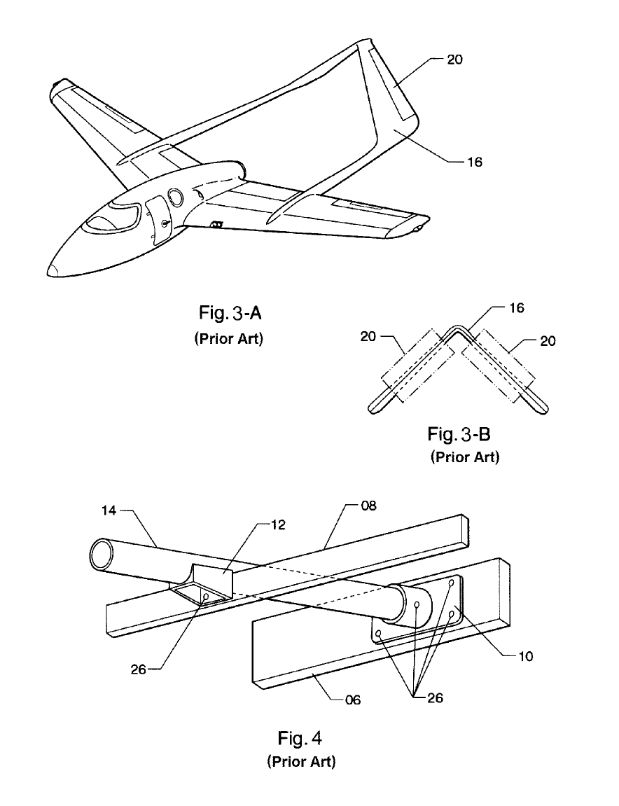

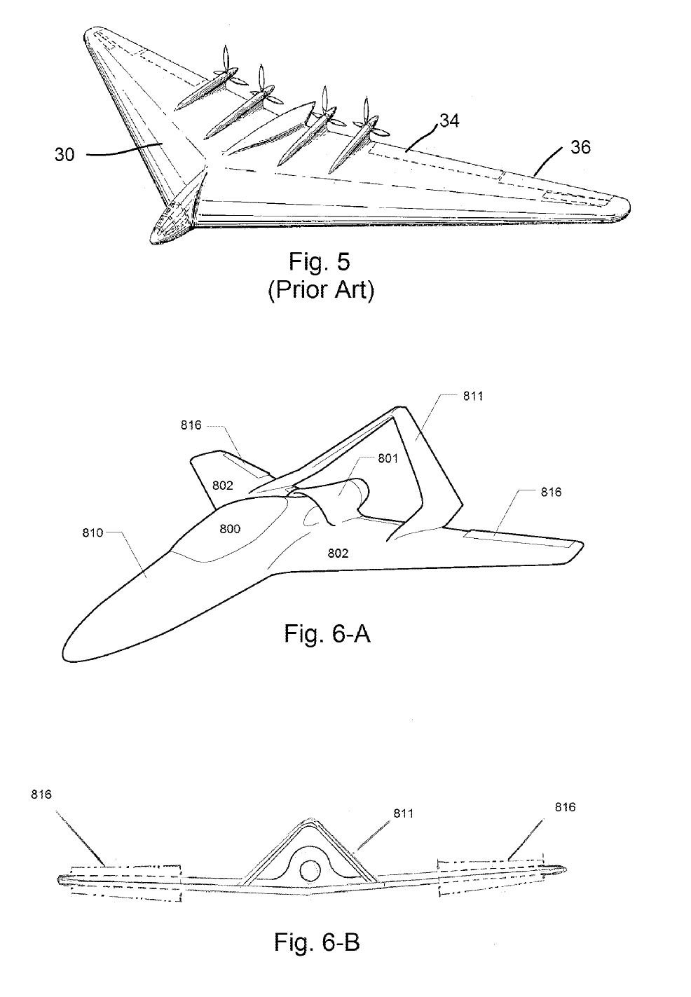

The Prior Art design shown in FIG. 3-A and FIG. 3-B is very different from applicant's present invention. Namely, in the existing design FIG. 3-B air pressure generated by forward thrust strikes the Ruddervators 20, altering the direction of flight. In the present invention, as illustrate in FIG. 6-B, elevons 816 may act also as split rudders, and may be split to provide drag resistance on one side of the aircraft. The air pressure generated by forward thrust strikes the elevons 816 thus altering the direction of forward flight around the center of gravity of said aircraft. Both elevons 816 may be also be split simultaneously to also act as drag flaps, in order to reduce aircraft speed.

The Simplified Inverted V-Tail Stabilizers results in a tail assembly that has fewer parts, is lighter, safer and less costly to manufacture. In addition, using elevons 816 for basic flight control maneuvering and dedicated-fixed simplified inverted “V” tail stabilizers 811 used for both pitch and yaw stability vastly increases the overall stability of the aircraft thus eliminating the chance of the aircraft going into a stall or spin by mishandling of the controls by the pilot, or an aircraft upset/spin induced by rough and turbulent weather conditions. Basic construction can utilize aluminum or composite fiberglass/carbon cloth and epoxy resin.

Initial testing of Simplified Inverted V-Tail Stabilizers consisted of first computer modeling the design. Next, a ⅙ scale radio-controlled model was made for flight testing. After flight testing, the elevons and the inverted V-tail stabilizer were inspected and adjusted for optimization.

The results of testing as noted above showed that the Simplified Inverted V-Tail Stabilizers have vastly improved performance due to a lighter weight structure with excellent handling qualities. In addition the tail structure withstood the applied flight loads with no observation of damage or fatigue cracking and thus the testing can be considered a complete success.

As noted previously, an inverted V-tail design is shown in Applicant's Prior Art Patent. The use of elevons is known in other aircraft, such as the Northrup B2 and other flying wing type aircraft. However, the use of elevons in an aircraft having a tail structure, such as applicant's inverted V-tail structure is not taught or suggested by the Prior Art. As is well-known in the art, flying wing type aircraft can be dynamically unstable and may require fly-by-wire computer controls to stabilize. The present invention solves this problem by providing a simplified inverted V-tail which provides aircraft stabilization, while at the same time simplifying control configuration over applicant's Prior Art design using ruddervators. The simplified construction reduces the complexity and number of control surfaces, as well as associated linkages. The embodiment of FIG. 6-A, in particular, eliminates all control surfaces from the inverted V-tail, which simplifies construction and reduces assembly costs.

While the preferred embodiment and various alternative embodiments of the invention have been disclosed and described in detail herein, it may be apparent to those skilled in the art that various changes in form and detail may be made therein without departing from the spirit and scope thereof.

I claim:

1. An improved aircraft having improved slow and high speed handling characteristics, said improved aircraft comprising:
fuselage;
a wing, extending from both sides of the fuselage;
a thrust generating means mounted to said fuselage, for generating thrust rearward along a longitudinal axis of said fuselage;
at least two inwardly inclined fin stabilizers, each coupled to the wing and inclined toward one another, positioned such that substantially all of the thrust generated by the thrust generating means is channeled between the at least two inwardly inclined fin stabilizers so as to enhance performance of said at least two inwardly inclined inwardly inclined fin stabilizers, and
the wing, extending from both sides of the fuselage, having on each side an elevon providing elevation, aileron, and rudder control for the aircraft.

2. The aircraft of claim 1, wherein the at least two inwardly inclined fin stabilizers having no moving control surfaces mounted thereon;

3. The aircraft of claim 1, wherein said thrust generating means comprises:
an engine, housed in a rear portion of the fuselage; and
a propeller, coupled to the engine and mounted at the rear portion of the fuselage in a pusher configuration between the pair of tail booms so as to generate thrust between the pair of tail booms such that substantially all of the thrust is channeled between the pair of inwardly canted fin stabilizers.

4. The aircraft of claim 1, wherein said thrust generating means comprises:
a jet engine, housed in a rear portion of the fuselage.

5. The aircraft of claim 2, wherein the elevons are split elevons, and for rudder control, one of the pair of elevons is split to cause the aircraft to turn in the direction of the split elevon.

6. An improved airplane, having improve slow and high speed handling characteristics, said improved airplane comprising:
a substantially teardrop-shaped fuselage section comprising a forward cockpit portion and a rear engine compartment portion;
a thrust generating means, housed in the engine compartment portion of the substantially teardrop-shaped fuselage section;
a wing, mounted to a side rear portion of the substantially teardrop-shaped fuselage section, said wing comprising a first portion and a second portion, the first portion extending outwardly from a first side of the substantially teardrop-shaped fuselage section, the second portion extending outwardly from a second side of the substantially teardrop-shaped fuselage section;
a pair of inwardly inclined fin stabilizers housing ruddervators, each attached to a rear portion of a corresponding one of the first and second portions of the wing, the pair of inwardly inclined fin stabilizers positioned such that substantially all of the thrust from the thrust generating means passes between and is channeled by the pair of inwardly inclined fin stabilizers so as to enhance performance of said at least two inwardly inclined fin stabilizers; and
the wing, extending from both sides of the fuselage, having on each side an elevon providing elevation, aileron, and rudder control for the aircraft.

7. The improved airplane of claim 6, where the at least two inwardly inclined fin stabilizers, have no moving control surfaces mounted thereon.

8. The improved airplane of claim 6, wherein said thrust generating means comprises:
an engine, housed in a rear portion of the fuselage; and
a propeller, coupled to the engine and mounted at the rear portion of the fuselage in a pusher configuration between the pair of tail booms so as to generate thrust between the pair of tail booms such that substantially all of the thrust is channeled between the pair of inwardly canted fin stabilizers.

9. The improved airplane of claim 6, wherein said thrust generating means comprises:
a jet engine, housed in a rear portion of the fuselage.

10. The aircraft of claim 7, wherein the elevons are split elevons, and for rudder control, one of the pair of elevons is split to cause the aircraft to turn in the direction of the split elevon.
